(19) United States
(12) Patent Application Publication
(10) Pub. No.: US 2024/0159544 A1
(43) Pub. Date: May 16, 2024

(54) System and Method for Travel Time Estimation in Real-Time

(71) Applicant: Robert Bosch GmbH, Stuttgart (DE)

(72) Inventor: Sirajum Munir, Pittsburgh, PA (US)

(21) Appl. No.: 18/055,610

(22) Filed: Nov. 15, 2022

(51) Int. Cl. G01C 21/28; H04W 64/00

(52) U.S. Cl. CPC G01C 21/28; H04W 64/006

(57) ABSTRACT

A computer-implemented system and method relates to travel time estimation using wireless signals. First communication data is received from a first wireless transceiver at a first location. The first communication data includes identification data of a mobile communication device. The second communication data includes second communication data from a second wireless transceiver at a second location. The second communication data includes the identification data of the mobile communication device. The first communication data and the second communication data, which are associated with the mobile communication device, are extracted using the identification data. Travel time data is generated for the mobile communication device with respect to a travel segment, defined between the first location and the second location, using the first communication data and the second communication data. The aggregated travel time data is generated for the travel segment. The aggregated travel time data includes at least the travel time data of the mobile communication device. The aggregated travel time data is transmitted for visual representation on a display.

### FIELD

This disclosure relates generally to wireless communication systems and more particularly to travel time estimation based on wireless signals.

### BACKGROUND

In general, there are several ways to estimate travel time. For example, smartphone-based navigation apps may report their GPS locations with different timestamps throughout their route to determine travel time. However, such GPS-based systems are not reliable in some environments due to obstacles, such as skyscrapers, tunnels, mountains, etc. Also, as another example, there are cameras deployed at specific locations along roadways that can be leveraged to recognize license plates of vehicles. If the same license plate is recognized between two points of a road network, then the time difference between those license plate recognitions can be used to determine travel time between those two points. However, such automatic license plate recognition systems are not reliable when there is poor lighting (e.g., night-time, etc.), bad weather (e.g., rain, snow, hail, fog, etc.), motion blur, occlusion (e.g., objects, animals, other vehicles, etc.), light reflections, images with cluttered backgrounds near the license plates, limited image resolution, and other situations.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method relates to travel time estimation. The method includes receiving first communication data from a first wireless transceiver at a first location. The first communication data includes identification data of a mobile communication device. The method includes receiving second communication data from a second wireless transceiver at a second location. The second communication data includes the identification data of the mobile communication device. The method includes identifying the first communication data and second communication data associated with the mobile communication device using the identification data. The method includes generating travel time data for the mobile communication device with respect to a travel segment using the first communication data and the second communication data. The travel segment is defined between the first location and the second location. The method includes generating aggregated travel time data for the travel segment. The aggregated travel time data includes at least the travel time data of the mobile communication device for the travel segment. The method includes transmitting the aggregated travel time data for visual representation on a display.

According to at least one aspect, a system includes at least a first wireless transceiver, a second wireless transceiver, and a computer server. The first wireless transceiver is located at a first location. The first wireless transceiver captures first communication data. The first communication data includes identification data of a mobile communication device communicating at the first location. The second wireless transceiver is located at a second location. The second wireless transceiver captures second communication data. The second communication data includes identification data of the mobile communication device communicating at the second location. The computer server is in wireless data communication with the first wireless transceiver. The computer server is in wireless data communication with the second wireless transceiver. The computer server is configured to perform a method, which includes storing first communication data from the first wireless transceiver in a database system. The method includes storing second communication data from the second wireless transceiver in the database system. The method includes identifying the first communication data and second communication data associated with the mobile communication device using the identification data. The method includes generating travel time data for the mobile communication device with respect to a travel segment, defined between the first location and the second location, using the first communication data and the second communication data. The method includes generating aggregated travel time data for the travel segment. The aggregated travel time data includes at least the travel time data of the mobile communication device for the travel segment. The method includes transmitting the aggregated travel time data for visual representation in response to a request for the aggregated travel time data.

According to at least one aspect, a non-transitory computer readable medium has computer readable data including instructions stored thereon that when executed by a processor is configured to cause the processor to perform a method. The method includes receiving first communication data from a first wireless transceiver at a first location. The first communication data includes identification data of a mobile communication device. The method includes receiving second communication data from a second wireless transceiver at a second location. The second communication data includes the identification data of the mobile communication device. The method includes identifying the first communication data and second communication data associated with the mobile communication device using the identification data. The method includes generating travel time data for the mobile communication device with respect to a travel segment defined between the first location and the second location using the first communication data and the second communication data. The method includes generating aggregated travel time data for the travel segment. The aggregated travel time data includes at least the travel time data of the mobile communication device for the travel segment. The method includes transmitting the aggregated travel time data for visual representation on a display.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1 is a diagram of an example of a system for travel time estimation according to an example embodiment of this disclosure.

FIG. 2 is a diagram of an example of a remote system according to an example embodiment of this disclosure.

FIG. 3A is a flow diagram of an installation process of a wireless transceiver according to an example embodiment of this disclosure.

FIG. 3B is a flow diagram of an operation process of a wireless transceiver according to an example embodiment of this disclosure.

FIG. 4 is a flow diagram of a process of the remote system according to an example embodiment of this disclosure.

FIG. 5 is a diagram of a non-limiting example of a visualization of the travel time data according to an example embodiment of this disclosure.

FIG. 6 is a diagram of a non-limiting example of a visualization of the travel time data according to an example embodiment of this disclosure.

FIG. 7 is a diagram of a non-limiting example of a visualization of the travel time data generated by the remote system according to an example embodiment of this disclosure.

FIG. 8 is a diagram of a non-limiting example of a visualization of the travel time data generated by the remote system according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling within the spirit and scope of this disclosure.

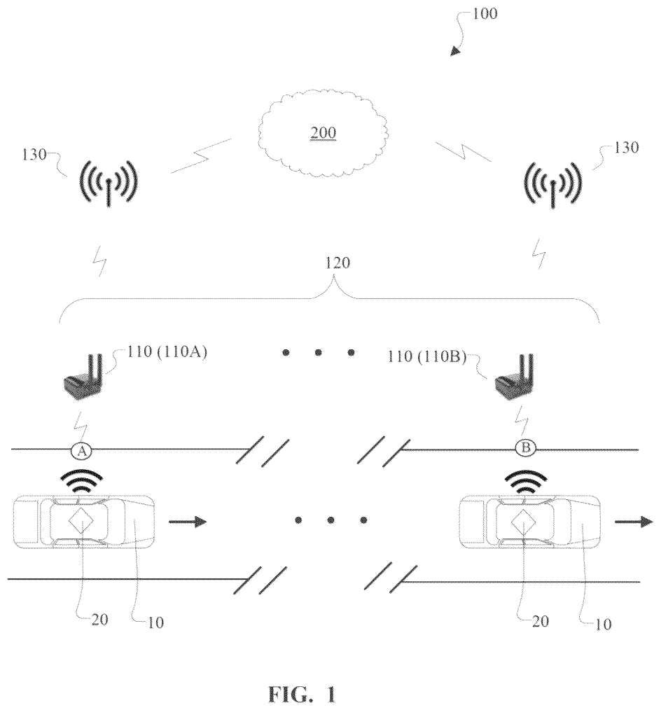

FIG. 1 is a non-limiting example of a system 100 relating to travel time estimation. This system 100 leverages wireless signals from one or more mobile communication devices 20 (e.g., smartphones, smartwatches, tablets, laptops, or other electronic/computer devices with wireless communication connectivity) to determine travel time between predetermined locations. The system 100 is configured to operate effectively in various unfavorable situations, such as when there is poor lighting, bad weather, motion blur, other inferior conditions, or any number and combination thereof. The system 100 is configured to generate travel time data for a mobile communication device, which is communicating wirelessly while also moving along a predetermined travel segment from one location (referred to as “location A”) to another location (referred to as “location B”). For example, in FIG. 1, the mobile communication device 20 is a part of a vehicle 10 or associated with the vehicle 10. The vehicle 10 may be any type of mobile machine (e.g., sedan, truck, bus, motorcycle, bicycle, robot, train, subway, aircraft, boat, etc.), which is associated with at least one mobile communication device 20.

The system 100 includes at least a wireless transceiver system 120 and a remote system 200, which communicate with each other via a communication network 130. The wireless transceiver system 120 includes at least wireless receiver units. For example, in FIG. 1, the system 100 includes wireless transceivers 110, which include wireless transmitter and receiver units. More specifically, in FIG. 1, the system 100 includes at least a wireless transceiver 110A at a first location (e.g., location A) and a wireless transceiver 110B at a second location (e.g., location B). Each location, which is associated with the wireless transceiver system 120, is specified by location data, such as an address that describes and specifies a location of a wireless transceiver 110. In FIG. 1, for instance, the wireless transceiver 110A is associated with location A (e.g., the intersection at McKnight Rd. and Siebert Rd at Ross Park Mall) and the wireless transceiver 110B is associated with location B (e.g., a particular arrival/departure spot at Pittsburgh International Airport).

In FIG. 1, each wireless transceiver 110 includes at least one or more radio frequency (RF) transceivers with one or more chipsets. A chipset may comprise a Wi-Fi chipset, a Bluetooth® chipset, an ultra-wideband (UWB) chipset, a cellular chipset (e.g. 4G, 5G, 6G, etc.), any wireless communication chipset, or any suitable number and combination thereof. A wireless transceiver 110 is configured to be installed at any suitable location (e.g., adjacent to, above, etc.) of a travel route. For example, there may be one or more wireless transceivers 110 installed independently with respect to a road network (e.g., installed at one or more sides of the road network). A wireless transceiver 110 may be a part of a video camera unit, which is located along a predetermined travel route. A wireless transceiver 110 may be installed with a traffic light and/or any other structure. Each wireless transceiver 110 is configured to connect to a cloud or the internet via a communication network 130. The communication network 130 may include a cellular network (e.g., 4G, 5G, 6G, etc.), an Ethernet network, any suitable communication technology, or any number and combination thereof. Each wireless transceiver 110 (or wireless receiver unit) includes one or more antennas for connecting with the communication network 130.

Also, in an example embodiment, each wireless transceiver 110 is configured to communicate with the remote system 200 via a communication protocol that enables the remote system 200 to receive the communication data. As an example, for instance, each wireless transceiver 110 and the remote system 200 may communicate via Extensible Messaging and Presence Protocol (XMPP), Message Queuing Telemetry Transport (MQTT), ZeroMQ, any communication protocol, or any number and combination thereof.

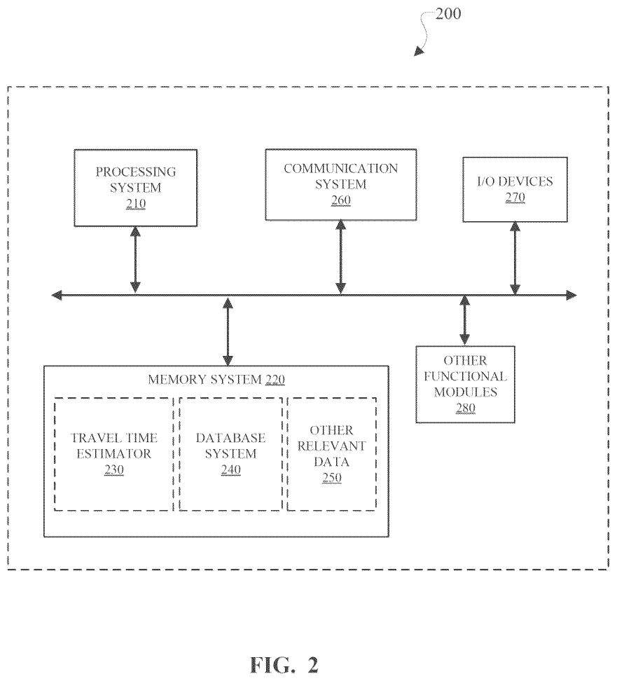

FIG. 2 is a diagram of an example of the remote system 200 according to an example embodiment. The remote system 200 is configured to generate travel time data based on wireless signals. The remote system 200 is also configured to provide this travel time data to one or more downstream applications and/or downstream devices. The remote system 200 includes a processing system 210 with at least one processing device. For example, the processing system 210 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. In FIG. 2, for instance, the processing system 210 includes a central server, a cloud computing system, or any number and combination thereof. The processing system 210 is operable to provide the functionality as described in this disclosure.

The remote system 200 includes a memory system 220, which is operatively connected to the processing system 210. The memory system 220 includes at least one non-transitory computer readable storage medium, which is configured to store and provide access to various data to enable at least the processing system 210 to perform the operations and functionality, as disclosed herein. The memory system 220 comprises a single memory device or a plurality of memory devices. The memory system 220 can include electrical, electronic, magnetic, optical, semiconductor, electromagnetic, or any suitable storage technology that is operable with the remote system 200. For instance, the memory system 220 includes random access memory (RAM), read only memory (ROM), flash memory, a disk drive, a memory card, an optical storage device, a magnetic storage device, a memory module, any suitable type of memory device, or any number and combination thereof. With respect to the processing system 210 and/or other components of the remote system 200, the memory system 220 is local, remote, or a combination thereof (e.g., partly local and partly remote). For example, the memory system 220 can include at least a cloud-based storage system (e.g. cloud-based database system), which is remote from the processing system 210 and/or other components of the remote system 200.

The memory system 220 includes at least a travel time estimator 230, a database system 240, and other relevant data 250, which are stored thereon. The travel time estimator 230 includes computer readable data with instructions, which, when executed by the processing system 210, is configured to generate various travel time data (e.g., travel time data for one or more mobile communication devices 20, aggregated travel time data for a set of mobile communication devices 20, aggregated travel time data for vehicles with wireless communication devices, etc.) for various travel segments. The computer readable data can include instructions, code, routines, various related data, any software technology, or any number and combination thereof. The database system 240 includes at least one database, any suitable electronic/computer data store, or any number and combination thereof. For example, in FIG. 2, the database system 240 comprises at least one or more databases, which may include a time series database (e.g., InfluxDB, MongoDB), a cloud-based data store (e.g., Google Bigtable, Amazon Athena, etc.), or any number and combination thereof. Meanwhile, the other relevant data 250 provides various data (e.g. operating system, etc.), which enables the remote system 200 to perform the functions as discussed in this disclosure.

In addition, the remote system 200 may include other components, such as a communication system 260, input/output (I/O) devices 270, and other functional modules 280. The communication system 260 includes communication technology that enables the remote system 200 to communicate with the wireless transceiver system 120. The I/O devices 270 may include any suitable input device, output device, or a combination thereof. For example, the I/O devices 270 may include one or more display devices, one or more keyboards, one or more speakers, one or more microphones, one or more mouses, one or more modems, one or more printers, etc. The other functional modules 280 may include any hardware, software, or combination thereof that assist with or contribute to the functioning of the remote system 200. For example, the other functional modules 280 include communication technology (e.g. wired communication technology, wireless communication technology, or a combination thereof) that enables components of the remote system 200 to communicate with each other as described herein.

As aforementioned, the remote system 200 is operable to generate travel time data, as described herein, and provide this travel time data as output data to one or more users. For example, upon generating the travel time data, the remote system 200 is configured to provide this travel time data in response to a request for such travel time data. The remote system 200 is configured to provide this travel time data by permitting and/or authorizing a downstream application and/or downstream device to access the travel time data. The remote system 200 is configured to provide and/or transmit the travel time data to one or more downstream applications and/or one or more downstream connected devices. The travel time data may include travel time data of a single mobile communication device 20, travel time data of a set of mobile communication devices 20, aggregated travel time data, summarized travel time data, any type of travel time data associated with one or more mobile communication devices 20 that are communicating wirelessly with respect to one or more travel segments, or any number and combination thereof.

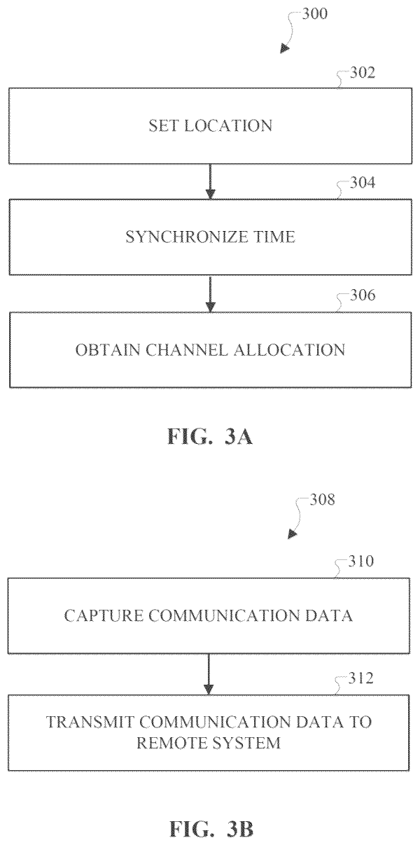

FIG. 3A is a flow diagram that illustrates an installation process 300 of a wireless transceiver 110 of the system 100 according to an example embodiment. The wireless transceiver 110 is configured to perform the installation process 300 during an installation mode. The installation process 300 may include more steps or less steps than that expressed in FIG. 3A provided that similar functions and objectives are achieved. Furthermore, although the installation process 300 is described with respect to a single wireless transceiver 110 in FIG. 3A, this installation process 300 is applied to each of the wireless transceivers 110 communicatively connected to the system 100. The wireless transceiver 110 performs the installation process 300 of FIG. 3A prior to the operation process 308 of FIG. 3B. An example of the installation process 300 for a wireless transceiver 110 is described below.

At step 302, according to an example, the wireless transceiver 110 is set with location data. More specifically, the wireless transceiver 110 is assigned to its current location. For example, in FIG. 1, the wireless transceiver 110A is positioned at location A and thus assigned to location A, where location A represents an address of a physical location. Also, as another example, in FIG. 1, the wireless transceiver 110B is positioned at location B and thus assigned to location B, where location B represents an address of a physical location that is different from location A. The assignment of location data (e.g., address) to a wireless transceiver 110 can be performed manually while commissioning. Additionally or alternatively, the assignment of a wireless transceiver 110 can be performed using Global Positioning System (GPS), any suitable localization system, or any number and combination thereof.

At step 304, according to an example, the wireless transceiver 110 synchronizes a time of its clock. More specifically, the wireless transceiver 110 updates its clock to a current date and a current time using a time synchronization protocol. As a non-limiting example, the time synchronization protocol includes Network Time Protocol (NTP), any time synchronization algorithm, or any number and combination thereof. The wireless transceiver 110 may update its clock to a current time based on a time zone associated with the location data, which was assigned at step 302. After time synchronization, the wireless transceiver 110 is configured to use its clock to capture timestamp data in relation to the location, which was assigned at step 302. Next, the installation process proceeds to step 306.

At step 306, according to an example, the wireless transceiver 110 obtains its channel allocation. More specifically, the wireless transceiver 110 is assigned one or more wireless channels for listening and/or sniffing. For example, Wi-Fi (IEEE 802.11) operates in different bands (e.g., 2.4 GHz, 5 GHz, etc.) in which each band has multiple channels. In order to successfully receive a Wi-Fi packet, the wireless transceiver 110 needs to operate in the same channel that a Wi-Fi transmitter of the mobile communication device 20 is using when the mobile communication device 20 is performing Wi-Fi communications (e.g., Wi-Fi packet transmission and/or Wi-Fi packet reception). Since the Wi-Fi transmitter may be using any channel, the wireless transceiver 110 is configured to cycle through the different channels in order to cover the entire spectrum of a band. As an example, for instance, the wireless transceiver 110 includes multiple Wi-Fi chipsets to cover different channels. After channel allocation is performed, each Wi-Fi chipset of the wireless transceiver 110 cycles through its allocated Wi-Fi channels to receive all Wi-Fi packets in that channel. Additionally or alternatively to Wi-Fi, the wireless transceiver 110 may include and use other wireless communication technologies (e.g., Bluetooth®, ultra-wideband (UWB), etc.). Various techniques for channel allocation and/or hopping mechanisms can be employed by these other wireless communication technologies. For Bluetooth®, the wireless transceiver 110 is configured to listen to all the primary advertising channels with such channel allocation and/or hopping mechanisms. After channel allocation, the wireless transceiver 110 is configured to transition to operating mode, as discussed with respect to FIG. 3B.

FIG. 3B is a flow diagram that illustrates an operation process 308 of a wireless transceiver 110 of the system 100 according to an example embodiment. The wireless transceiver 110 is configured to operate the operation process 308 during an operating mode. The operation process 308 may include more steps or less steps than that expressed in FIG. 3B provided that similar functions and objectives are achieved. Furthermore, although the operation process 308 is described with respect to a single wireless transceiver 110 in FIG. 3B, this operation process 308 is applicable to each of the wireless transceivers 110 communicatively connected to the system 100. The wireless transceiver 110 performs the operation process 308 of FIG. 3B after the installation process of FIG. 3A. An example of operation process 308 for a wireless transceiver 110 is described below.

At step 310, according to an example, the wireless transceiver 110 captures communication data when operating in operation mode. More specifically, when a mobile communication device 20 communicates (e.g., transmits and/or receives) a set of packets at a particular location, then the wireless transceiver 110 captures communication data corresponding to each packet at that particular location. For example, the communication data includes (a) location data of the wireless transceiver 110 at its current location, (b) identification data of the mobile communication device 20 communicating (e.g., transmitting) at that same current location of the wireless transceiver 110, and (c) a set of timestamp data respectively corresponding to a set of packets being communicated (e.g., transmitted) by the mobile communication device 20 at that same current location of that same wireless transceiver 110. In addition, the communication data is configured to include a set of received signal strength indicator (RSSI) data respectively corresponding to the set of packets being communicated by the mobile communication device 20 at that same current location of that same wireless transceiver 110. The communication data may include the aforementioned information in any particular order. In addition, the wireless transceiver 110 is configured to include additional information with the aforementioned communication data, if desired.

As aforementioned, the communication data includes location data of a physical location, which is currently associated with the wireless transceiver 110 that is listening to the mobile communication device 20 at that physical location. For instance, the location data includes address data, which is assigned to the wireless transceiver 110 during the installation process 300. In addition, the communication data includes identification data, which uniquely identifies a mobile communication device 20 (or a network interface controller of that mobile communication device 20), which is communicating (e.g., transmitting/receiving packets) at a location of the wireless transceiver 110. As a non-limiting example, the identification data includes at least a Wi-Fi medium access control (MAC) address of the mobile communication device 20. Also, for data privacy, the wireless transceiver 110 and/or the remote system 200 is configured to hash the identification data to protect the privacy of a user and then later use/store the hashed version of the MAC address (e.g. hash code) as the identification data. Also, the communication data includes timestamp data. The timestamp data includes a set of timestamps that respectively correspond to a set of packets, which are being communicated by the mobile communication device 20 and which are being detected, sniffed, and/or overhead by the wireless transceiver 110. The timestamp data includes digital timestamps, which include at least the fill date and time, as generated by the clock of the wireless transceiver 110 that was synchronized at step 304. Also, the communication data includes received signal strength indicator (RSSI) data. The RSSI data includes a set of RSSI that respectively correspond to a set of packets, which are being communicated by the mobile communication device 20 and which are detected by the wireless transceiver 110.

Referring to FIG. 1, as an example, when the vehicle 10 reaches location A, then the wireless transceiver 110A at location A captures communication data D_{A}, which corresponds to a set of packets, which are being communicated via the mobile communication device 20 of the vehicle 10. In this case, the communication data D_{A} may be represented as D_{A}={Loc_{A}, IDᵥ, TS_{A}, RSSI_{A}}. The communication data D_{A} includes Loc_{A}, which refers to location data of the wireless transceiver 110A at its assigned location (e.g., location A). The communication data D_{A} includes IDᵥ, which refers to unique identification data (e.g., MAC address) of the mobile communication device 20 (e.g. network interface controller), which is performing wireless communications from the vehicle 10 at location A. The communication data D_{A} includes timestamp data TS_{A}, which refers to a set of timestamps that correspond respectively to a set of N packets being communicated by the mobile communication device 20 of the vehicle 10 in which N represents an integer greater than 1. For example, the timestamp data TS_{A} may be represented as TS_{A}={tsA₁, tsA₂, tsA₃, . . . tsA_{N}}, where tsA₁ represents the timestamp of the first packet, tsA₂ represents the timestamp of the second packet, tsA₃ represents the timestamp of the third packet, and so forth until tsA_{N} represents the timestamp of the Nth packet (or the timestamp of the last packet). This timestamp data is captured with respect to the set of packets, which the wireless transceiver 110A detects that the mobile communication device 20 is communicating (e.g., Wi-Fi packet transmission/reception) at location A. In addition, the communication data D_{A} includes RSSI data. The RSSI data includes a set of RSSI corresponding to a set of N packets with IDᵥ at location A, where N represents an integer number greater than 1. For example, the set of RSSI may be represented as RSSI_{A}={RSSI_{A1}, RSSI_{A2}, RSSI_{A3}, . . . RSSI_{AN}}, where RSSI_{A1} represents the RSSI of the first packet, RSSI_{A2} represents the RSSI of the second packet, RSSI_{A3} represents the RSSI of the third packet, and so forth until RSSI_{AN} represents the RSSI of the Nth packet (or the RSSI of the last packet), which is associated with IDᵥ of the mobile communication device 20 and which is generated by the wireless transceiver 110A at location A.

As another example, in FIG. 1, when the vehicle 10 reaches location B, then the wireless transceiver 110B at location B captures communication data D_{B}, which corresponds to a set of packets, which are being communicated from the same mobile communication device 20 of the same vehicle 10. In this case, the communication data D_{B} may be represented as D_{B}={Loc_{B}, IDᵥ, TS_{B}, RSSI_{B}}. The communication data D_{B} includes Loc_{B}, which refers to location data of the wireless transceiver 110B at its assigned location (e.g., location B). The communication data D_{B} includes IDᵥ, which refers to unique identification data (e.g., MAC address) of the mobile communication device 20 (e.g. network interface controller), which is performing wireless communications from the vehicle 10 at location B. In FIG. 1, for example this IDᵥ is the same unique identification data of the mobile communication device 20, which is associated with the vehicle 10. In this regard, in the example shown in FIG. 1, the communication data D_{A} and the communication data D_{B} include the same identification data (i.e., MAC address) of the mobile communication device 20 associated with the vehicle 10. In addition, the communication data D_{B} includes timestamp data TS_{B}, which refers to a set of timestamps that correspond respectively to a set of packets being communicated by the mobile communication device 20. For example, the timestamp data TS_{B}, may be represented as TS_{B}={tsB₁, tsB₂, tsB₃, . . . tsB_{N}}, where tsB₁ represents the timestamp of the first packet, tsB₂ represents the timestamp of the second packet, tsB₃ represents the timestamp of the third packet, and so forth until tsB_{N} represents the timestamp of the Nth packet (or the timestamp of the last packet). This timestamp data is captured with respect to the set of packets, which the wireless transceiver 110B is listening to the mobile communication device 20 communicate (e.g., Wi-Fi transmission/reception) at location B. In addition, the communication data D_{B} includes RSSI data. The RSSI data includes a set of RSSI corresponding to a set of N received packets with IDᵥ at location B. The set of RSSI may be represented as RSSI_{B}={RSSI_{B1}, RSSI_{B2}, RSSI_{B3}, . . . RSSI_{BN}}, where RSSI_{B1} represents the RSSI of the first packet, RSSI_{B2} represents the RSSI of the second packet, RSSI_{B3} represents the RSSI of the third packet, and so forth until RSSI_{BN} represents the RSSI of the Nth packet (or the RSSI of the last packet), which is associated with IDᵥ of the mobile communication device 20 and which is generated by the wireless transceiver 110B at location B.

At step 312, according to an example, the wireless transceiver 110 transmits the communication data to the remote system 200 via one or more communication networks 130. Referring to FIG. 1, as an example, upon capturing communication data D_{A}, the wireless transceiver 110A sends this communication data D_{A} to the remote system 200 via one or more communication networks 130. Also, as another example, in FIG. 1, upon capturing communication data D_{B}, the wireless transceiver 110B sends this communication data D_{B} to the remote system 200 via a communication network 130. The communication network 130 may include an Ethernet network, a cellular network, any communication technology, or any number and combination thereof.

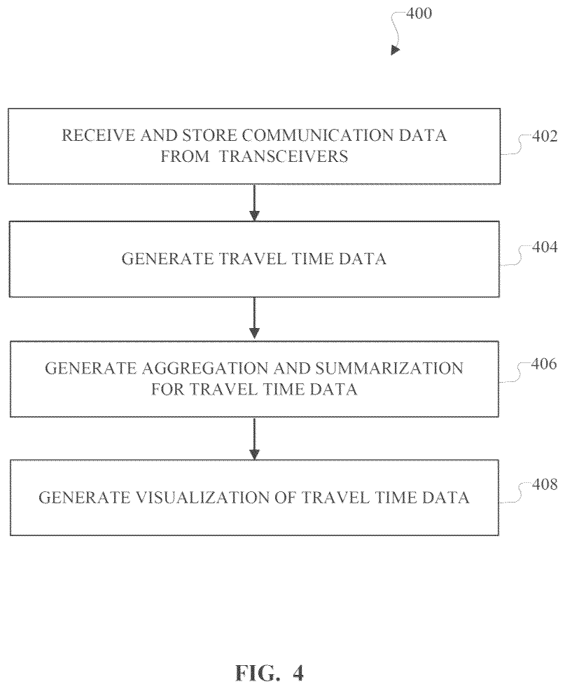

FIG. 4 is a flow chart that shows an example of a method 400 for travel time estimation according to an example embodiment. As discussed above, the remote system 200 may include a cloud-based system, a server-based system (e.g., centralized server system), any suitable computer, or any number and combination thereof. In this example, the method 400 is performed by the remote system 200 via the travel time estimator 230 of FIG. 2. More specifically, the processing system 210, which includes one or more processors, is configured to execute this method 400 in accordance with the travel time estimator 230. The method 400 may include more steps or less steps than that expressed in FIG. 4 provided that similar functions and objectives are achieved.

At step 402, according to an example, the remote system 200 receives communication data (e.g., communication data D_{A}, communication data D_{B}, etc.) from a plurality of wireless transceivers 110, which are communicatively connected to the system 100. Referring to FIG. 1, as an example, the remote system 200 receives communication data D_{A} from the wireless transceiver 110A at location A. The remote system 200 is configured to store the communication data DA in the database system 240. Also, in FIG. 1, the remote system 200 receives communication data DB from the wireless transceiver 110B at location B. The remote system 200 is configured to store the communication data DB in the database system 240.

At step 404, according to an example, the remote system 200 generates travel time data for a travel segment between location A and location B. In this regard, the remote system 200 is configured to ensure that the travel time data is properly computed by considering various aspects associated with time calculations. For example, the remote system 200 is configured to account for time zones, daylight savings time, international dateline, any time consideration, or any number and combination thereof. The remote system 200 is also configured to account for calculations involving timestamps from different days (e.g., traveling from 11 PM on one day to 1 AM on the next day).

As an example, for instance, the remote system 200 is configured to determine whether or not location A and location B are in different time zones. For example, during installation of wireless transceiver 110A and the wireless transceiver 110B and after setting their locations, the wireless transceiver 110A and the wireless transceiver 110B are configured to report their actual location data to the database system 240. The remote system 200 is configured to use this location data to determine if location A and location B are in different time zones. If the remote system 200 determines that location A and location B are in different time zones, then the remote system 200 adjusts at least one of their timestamp data to a common time zone before generating the travel time data. If the remote system 200 determines that location A and location B are in the same time zone, then the remote system 200 uses the timestamp data without making any time zone adjustments to the timestamp data.

With respect to the travel segment from location A to location B, the remote system 200 generates travel time data using communication data D_{A} and communication data D_{B}. More specifically, referring to FIG. 1, as an example, the remote system 200 retrieves communication data D_{A} from the database system 240. The remote system 200 extracts the identification data IDᵥ of the mobile communication device 20, which is associated with vehicle 10, from the communication data D_{A}. The remote system 200 then locates one or more subsequent time entries that have the same identification data IDᵥ in the database system 240. The relation (e.g., earlier or later) of timestamp data at one location with respect to timestamp data at another location may be used in determining direction of travel of the mobile communication device 20 along the travel segment. In FIG. 1, for example, the remote system 200 finds and retrieves communication data D_{B} from the database system 240.

Upon extracting the timestamp data and making any necessary time adjustments (e.g., timezones, etc.) to perform the proper travel time estimations, the remote system 200 generates travel time data TT_{AB,V} with respect to a mobile communication device 20 (e.g., network interface controller associated with the vehicle 10) moving along a predetermined travel segment from location A to location B via equation 1. More specifically, with respect to equation 1, the processing system 210 computes a median timestamp of the set of packets communicated by the mobile communication device 20 at location B. Referring to FIG. 1, as an example, with respect to the set of timestamp data TS_{B}={tsB₁, tsB₂, tsB₃, . . . tsB_{N}}, the processing system 210 computes the median timestamp with respect to tsB₁, tsB₂, tsB₃, . . . and tsB_{N}. In addition, the processing system 210 computes a median timestamp of the set of packets communicated by the mobile communication device 20 at location A. Referring to the example of FIG. 1, with respect to the set of timestamp data TS_{A}={tsA₁, tsA₂, tsA3, . . . tsA_{N}}, the processing system 210 computes the median timestamp with respect to tsA₁, tsA₂, tsA3, . . . and tsA_{N}. In addition, the processing system 210 generates travel time data TT_{AB,V} by computing the time difference between the median timestamp of the set of packets at location B and the median timestamp of the set of packets at location A, as expressed below.

TT_{AB}=median{TS_{B}}−median{TS_{A}} [1]

In another example, the remote system 200 generates travel time data TT_{AB,V} with respect to a mobile communication device 20 (e.g., network interface controller associated with the vehicle 10) moving along a predetermined travel segment from location A to location B via equation 2. More specifically, with respect to equation 2, the processing system 210 identifies the first timestamp of the first packet from among a set of packets communicated by the mobile communication device 20 at location B. Refering to FIG. 1, as an example, with respect to the set of timestamp data TS_{B}={tsB₁, tsB₂, tsB₃, . . . tsB_{N}}, the processing system 210 determines that the first timestamp is tsB₁ for the first packet of the mobile communication device 20 at location B. In addition, the processing system 210 identifies the last timestamp of the last packet from among a set of packets communicated by the mobile communication device 20 at location A. Referring to the example of FIG. 1, with respect to the set of timestamp data TS_{A}={tsA₁, tsA₂, tsA3, . . . tsA_{N}}, the processing system 210 determines that the last timestamp is tsA_{N} for the last packet of the mobile communication device 20 at location A. Accordingly, the processing system 210 generates travel time data TT_{AB,V} by computing the time difference between the first timestamp (e.g., tsB₁) of the first packet among a set of packets from the mobile communication device 20 at location B and the last timestamp (e.g., tsA_{N}) of the last packet from the mobile communication device 20 at location A, as expressed below.

TT_{AB}=first{TS_{B}}−last{TS_{A}} [2]

In yet another example, the remote system 200 generates travel time data TT_{AB,V} with respect to a mobile communication device 20 (e.g., network interface controller associated with the vehicle 10) moving along a predetermined travel segment from location A to location B via via equation 3. More specifically, with respect to equation 3, the processing system 210 determines a highest signal strength from among a set of received signal strengths of the communication data D_{B}. In addition, the processing system 210 extracts a timestamp ts_{Bj} from among the TS_{B}={tsB₁, tsB₂, tsB₃, . . . tsB_{N}} that corresponds to a highest signal strength from among RSSI_{B}={RSSI_{B1}, RSSI_{B2}, RSSI_{B3}, . . . RSSI_{BN}}. As a non-limiting example, if the highest signal strength (e.g., RSSI_{B3}) from among RSSI_{B} corresponds to the third packet, then the processing system 210 extracts the third timestamp (e.g., tsB₃) corresponding to the third packet from TS_{B} for location B. The processing system 210 also extracts a timestamp ts_{Ai} from among the TS_{A}={tsA₁, tsA₂, tsA3, . . . tsA_{N}} that corresponds to a highest signal strength from among RSSI_{A}={RSSI_{A1}, RSSI_{A2}, RSSI_{A3}, . . . RSSI_{AN}}. As a non-limiting example, if the highest signal strength (e.g., RSSI_{A2}) from among RSSI_{A} corresponds to the second packet, then the processing system 210 extracts the second timestamp (e.g., tsA₂) corresponding to the second packet from TS_{A} for location A. Accordingly, the processing system 210 generates travel time data TT_{AB,V} by computing the time difference between a timestamp (e.g., ts_{Bj}) corresponding to a highest RSSI at location B and a timestamp (e.g., ts_{Ai}) corresponding to a highest RSSI at location A, as expressed below.

TT_{AB}=ts_{Bj}-ts_{Ai} [3]

At step 406, according to an example, the remote system 200 performs aggregation and/or summarization of the travel time data for the predetermined travel segment between location A and location B. When travel time TT_{AB,V} is generated at step 404, the remote system 200 performs this estimation with respect to a single mobile communication device 20. Simultaneously or subsequently to generating travel time data TT_{AB,V} for that single mobile communication device 20, the remote system 200 generates travel time data TT_{AB,aggregated} for all mobile communication devices 20 (e.g., and/or vehicles 10), which are communicating wirelessly and which are identified as traveling from location A to location B during a predetermined timeframe (e.g., morning rush hour). In this regard, the remote system 200 aggregates and/or summarizes the travel time data for a set of mobile communication devices 20 in relation to the predetermined travel segment by computing average travel time or median travel time with respect to the aggregation and/or summarization. In addition, the remote system 200 generates aggregated travel time data and/or summarized travel time data for different times of the day, different days of the week, different parts of a city and state.

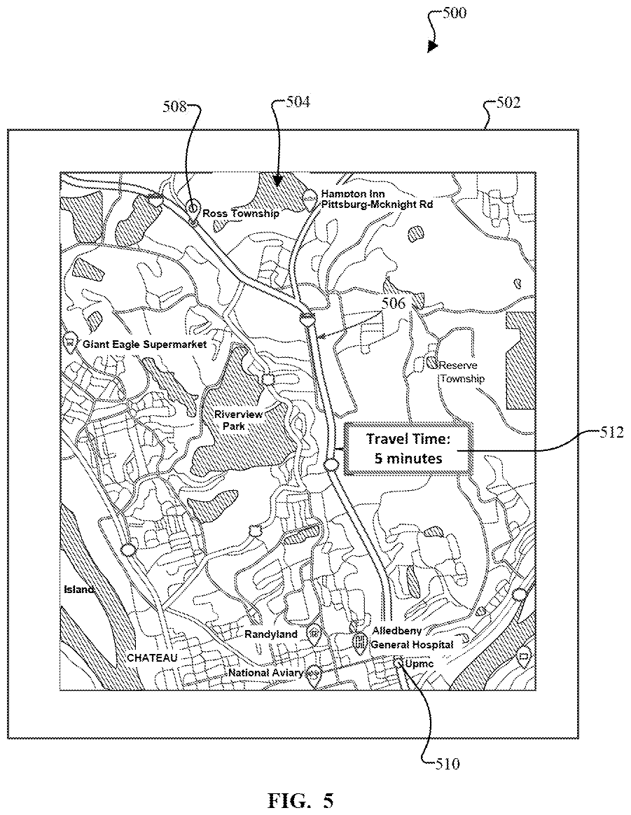

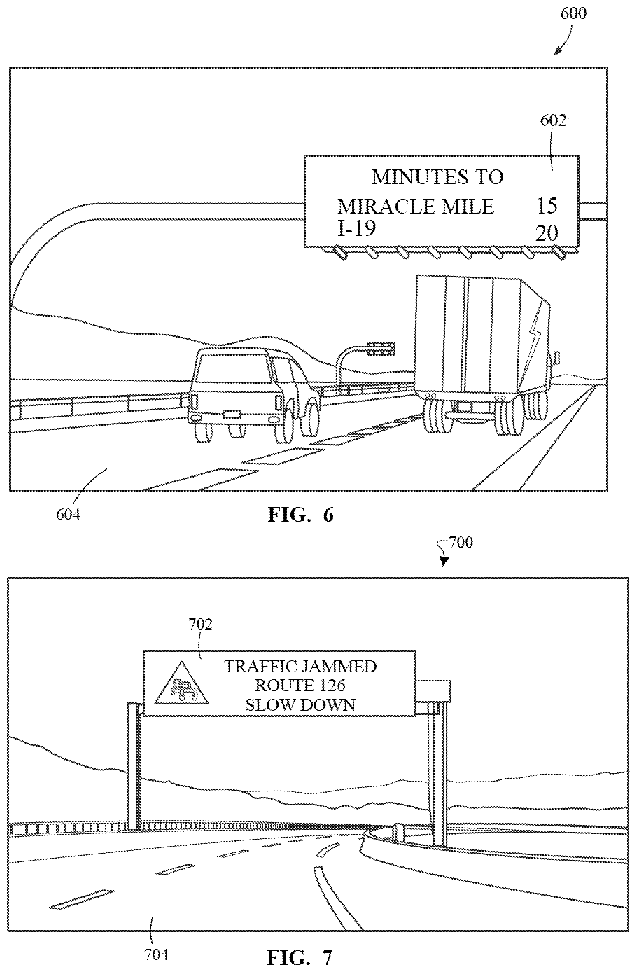

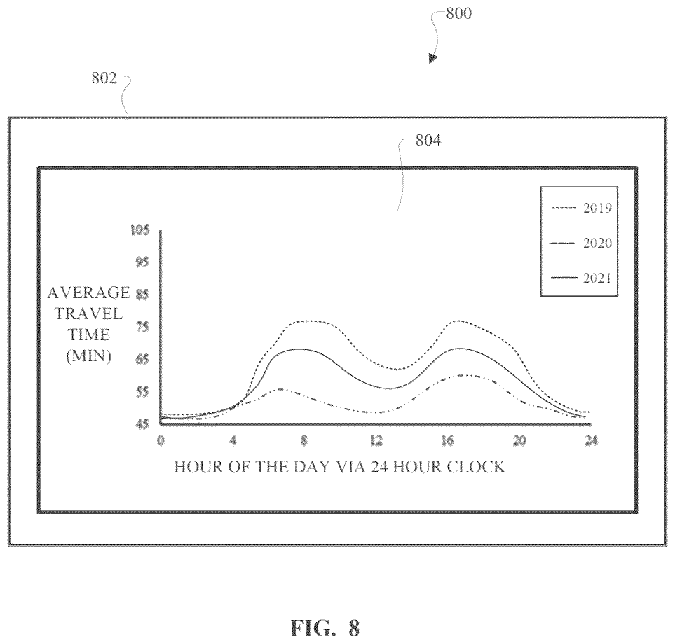

At step 408, according to an example, the remote system 200 provides the travel time data for output to an I/O device, which may be associated with the remote system 200. In this regard, the remote system 200 is configured to output the travel time data via I/O device 270. Additionally or alternatively, the remote system 200 is configured to provide the travel time data to another device, which is communicatively connected to the remote system 200. The another device may include a desktop, a laptop, a tablet, a phone, any computing device, any I/O device, or any number and combination thereof, which is not considered to be a part of the remote system 200. The another device may use an app or a browser to output the travel time data (e.g., travel time data of a single mobile communication device 20, travel time data of a set of mobile communication devices 20, aggregated travel time data, summarized travel time data, etc.). The app or browser may be configured such that access to or transmission of the travel time data is based on an authorization or authentication process. For instance, FIG. 5, FIG. 6, FIG. 7, and FIG. 8 illustrate non-limiting examples in which the travel time data is provided for visualization on another device, which is communicatively connected to the remote system 200 while also being independent from the remote system 200. Furthermore, although these examples illustrate cases in which the travel time data is output as visual data, the system 100 is also configured to provide the travel time data in another form, such as audio data.

FIG. 5 is a diagram of an example of a visualization 500, which includes at least the travel time data 512 received from the remote system 200 and displayed on a display device 502. The display device 502 is configured to receive the travel time data 512 from the remote system 200. For example, the display device 502 is a touchscreen of a mobile phone, a touchscreen of a tablet computer, a display monitor of a computer, etc. More specifically, in this example, the visualization 500 displays a map region 504 that highlights a travel segment 506, which is defined by a first location 508 (or a source location) and a second location 510 (or a destination location). The visualization 500 includes markers, such as a first marker to mark the first location 508 and a second marker to mark the second location 510 with respect to the travel segment 506 and the map region 504. In this case, the first marker indicates that first location 508 is a source location (or a current location) while the second marker indicates that the second location 510 is a destination location (or a noteworthy location). The visualization 500 highlights, emphasizes, and/or makes noticeable the travel segment 506 from the first location 508 to the second location 510. For example, in FIG. 5, the travel segment 506 is highlighted by a different color/style line.

In addition, the visualization 500 displays the travel time data 512 with respect to the travel segment 506 as an annotation, any suitable information display, or any combination thereof. The travel time data 512 may be displayed as an individual travel time, an aggregated travel time, or any number and combination. In this case, the visualization 500 shows the aggregated travel time for vehicles (e.g., as determined by mobile communication devices 20 associated with these vehicles) moving along the travel segment 506, which comprises a road segment from the first location (e.g., “Ross Township”) to the second location (e.g., “Upmc”). In addition, the visualization 500 indicates a unit of measurement of the travel time data 512. As a non-limiting example, in FIG. 5, the visualization 500 includes the travel time data of “5,” and the unit of measure of “minutes,” as well as an indication this data refers to travel time from the first location to the second location. In this case, the travel time data of “5 minutes” refers to the aggregated travel time for vehicles along the predetermined travel segment 506, which is between one location (e.g. location A being “Ross Township”) and another location (e.g., location B being “Upmc”) and which includes a direction from that one location to that another location. In this case, the remote system 200 generates this aggregated travel time data from a large set of mobile communication devices 20 (e.g., phones, tablets, smartwatches, wireless vehicle components, etc.), which are associated with various vehicles and which communicate wirelessly at location A (e.g., “Ross Township”) prior to communicating wirelessly at location B.

FIG. 6 is a diagram of an example of a visualization 600 of the travel time data. For example, in FIG. 6, the visualization 600 includes at least the travel time data, which is received from the remote system 200 and displayed on a display device 602. In this example, the display device 602 is disposed above a part of travel segment (e.g., highway 604). Alternatively, the display device 602 may be disposed adjacent to and/or along a side of the travel segment, such as a road, sidewalk, etc. The display device 602 may be an electronic message board, an electronic display, a digital display, an LED display, an LCD display, any suitable display technology, or any number and combination thereof. For example, in FIG. 6, the display device 602 is a digital display, which shows first travel time data (e.g., 15 minutes) from that current location (e.g., location A) to a first destination location (e.g., “MIRACLE MILE” or location B). In addition, the display device 602 also shows second travel time data (e.g., 20 minutes) from that current location (e.g., location A) to a second destination location (e.g., “I-19” or location C). In this regard, the remote system 200 is configured to generate and provide one or more travel time data (e.g., first travel time data and second travel time data) regarding one or more travel segments (e.g., first travel segment from location A to location B, a second travel segment from location A to location C, etc.). In this case, the remote system 200 generated this aggregated travel time data from a large set of mobile communication devices 20 (e.g., phones, tablets, smartwatches, wireless vehicle components, etc.), which are associated with vehicles and which communicate wirelessly at location A (e.g., current location) prior to communicating wirelessly at location B (e.g., MIRACLE MILE) and location C (e.g., I-19), respectively.

In addition, the display device 602 also displays a unit of measurement of the travel time data together with the travel time data for added clarity. As a non-limiting example, with respect to the first travel segment from location A to location B, the display device 602 includes the travel time data of “15” and the unit of measure of “minutes,” as well as an indication this first travel time data refers to a first travel segment location A to location B. Also, as another non-limiting example, with respect to the second travel segment from location A to location C, the display device 602 includes the travel time data of “20” and the unit of measure of “minutes,” as well as an indication this second travel time data refers to the second travel segment from location A to location C. Although the display device 602 provides the unit of time measurement by displaying “MINUTES TO” before providing the destination locations and the travel time data, the display device 602 may display any suitable unit of measure (e.g. hours, minutes, seconds, etc.) in any suitable manner (e.g., any suitable message). As shown in FIG. 6, these features of the visualization 600 are advantageous in that the remote system 200 and/or downstream display device 602 is configured to provide a plurality of travel time data from a current location to different locations based on different travel segments, thereby allowing for a comparison of travel time data along those different travel segments (e.g., travel segment from location A to location B or travel segment from location A to location C). These features provide drivers and/or users with the benefit of being enabled to determine their routing options and estimated arrival times while on their travel route.

FIG. 7 is a diagram of an example of a visualization 700 of the travel time data. For example, in FIG. 7, the visualization 700 includes a display device 702, which dynamically displays a message based on the travel time data. In this example, the display device 702 is disposed above a part of travel segment (e.g., highway 704). Alternatively, the display device 702 may be disposed adjacent to and/or along a side of the travel segment, such as a road, sidewalk, etc. The display device 702 may be an electronic message board, an electronic display, a digital display, an LED display, an LCD display, any suitable display technology, or any number and combination thereof. In this regard, for example, the remote system 200 is configured to provide the travel time data to a downstream application, which is then used to show one or more variable messages based on the travel time data. That is, instead of showing the travel time data itself, the display device 702 shows a message that is generated or selected based on the travel time data, which is generated by the remote system 200.

In FIG. 7, for instance, after the travel time data is generated, the remote system 200 and/or a downstream computer system determines that the travel time data (e.g., aggregated travel time data of 45 minutes) is greater than a threshold (e.g., 30 minutes). In this case, the remote system 200 and/or downstream computer system determines that the travel time data for a predetermined travel segment from location A to location B is greater than a predetermined value and/or within a predetermined range such that the travel time data indicates there is most likely a traffic jam along the predetermined travel segment that is causing the travel time to be greater than the threshold. Based on this assessment, the remote system 200 and/or a downstream computer system selects the message “TRAFFIC JAMMED, ROUTE 126, SLOW DOWN” to be displayed on the display device 702. In this example, the display device 702 displays one or more variable messages using the travel time data to notify travelers about traffic flow along the travel segment. As shown in FIG. 7, this feature is advantageous in that the remote system 200 and/or downstream computer system is configured to provide meaning, insight, and/or advice with respect to the travel segment based on the travel time data.

FIG. 8 is a diagram of an example of a visualization 800 of the travel time data. In this case, the remote system 200 and/or a downstream computer system is configured to aggregate, summarize, and display a graphical representation 804 of the travel time data on a display device 802. The display device 802 may be an electronic display, a digital display, an LED display, an LCD display, any suitable display technology, or any number and combination thereof. The display device 802 may be at least one I/O device of the remote system 200 and/or at least one I/O device of a downstream computer system. The average travel time data, e.g., taken in minutes for the y-axis, may be computed for a travel segment from a first location to a second location at different times (e.g., different hours such as 4 A.M., 8 A.M., 12 P.M., 4 P.M., 8 P.M., and 12 A.M. as a scale for the x-axis) for a given year. Also, as a non-limiting example, the remote system 200 and/or downstream computer system is configured to display graphical representations 804 of the average travel time data for the same travel segment at those selected times of the day for different years (e.g., 2019 year, 2020 year, and 2021 year), as shown in FIG. 8, for comparison. Additionally or alternatively, as another non-limiting example (not shown), the remote system 200 and/or downstream computer system is configured to summarize travel time of different locations, of an entire city, and at different days of the week. As discussed above, this type of visualization 800 (e.g., graphical representation 804) is advantageous in that such travel time information may be used by certain users (e.g., city officials) to control traffic lights and plan road networks for efficient traffic management. Also, as another example, this type of visualization 800 is advantageous in enabling users to determine efficient times for traveling along a predetermined travel segment based on this visualization 800 of the travel time data (e.g., aggregated and summarized travel time data).

As described in this disclosure, the system 100 provides a number of advantages and benefits. For example, the system 100 utilizes wireless signals to generate travel time data in real-time. The system 100 leverages a network of wireless transceivers 110 to obtain communication data (e.g., location data, timestamps, ID data, RSSI data, etc.) to generate various travel time data. The system 100 also leverages various types of mobile communication devices 20 (e.g., mobile phones, laptops, wireless access points, wireless routers connected to power systems of vehicles, etc.) to generate communication data (e.g., communication data D_{A}, communication D_{B}, etc.), which is used to generate travel time data. The system 100 is configured to generate travel time data for a predetermined travel segment even when there is poor lighting (e.g., night-time, etc.), motion blur, occlusion (e.g., objects, animals, other vehicles, etc.), bad weather, or a number of other poor imaging situations, thereby overcoming the deficiencies of camera-based systems for generating travel time data. In addition, the system 100 is configured to operate better than GPS-based systems in some instances, such as in some city areas in which buildings and other structures may block GPS signals, as well as in other poor GPS signal receiving situations.

That is, the above description is intended to be illustrative, and not restrictive, and provided in the context of a particular application and its requirements. The present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the tue scope of the embodiments and/or methods of the present invention are not limited to the embodiments shown and described, since various modifications will become apparent upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A computer-implemented method for travel time estimation, the method comprising:
receiving first communication data from a first wireless transceiver at a first location, the first communication data including identification data of a mobile communication device;
receiving second communication data from a second wireless transceiver at a second location, the second communication data including the identification data of the mobile communication device;
extracting the first communication data and the second communication data associated with the mobile communication device using the identification data;
generating travel time data for the mobile communication device with respect to a travel segment defined between the first location and the second location using the first communication data and the second communication data;
generating aggregated travel time data for the travel segment, the aggregated travel time data including at least the travel time data of the mobile communication device for the travel segment; and
transmitting the aggregated travel time data for visual representation on a display.

2. The computer-implemented method of claim 1, wherein the identification data is based on a media access control (MAC) address associated with the mobile communication device.

3. The computer-implemented method of claim 1, wherein:
the first communication data includes at least (a) first location data of the first location, (b) the identification data of the mobile communication device, (c) a first set of timestamp data respectively corresponding to a first set of packets the mobile communication device at the first location, and (d) a first set of received signal strength data respectively corresponding to the first set of packets; and
the second communication data includes at least (a) second location data of the second location, (b) the identification data of the mobile communication device, (c) a second set of timestamp data respectively corresponding to a second set of packets of the mobile communication device at the second location, and (d) a second set of received signal strength data respectively corresponding to the second set of packets.

4. The computer-implemented method of claim 3, further comprising:
computing a first median timestamp based on the first set of timestamp data corresponding to a first set of packets transmitted by the mobile communication device at the first location; and
computing a second median timestamp based on the second set of timestamp data corresponding to a second set of packets transmitted by the mobile communication device at the second location,
wherein the travel time data is generated based on a difference between the second median timestamp and the first median timestamp.

5. The computer-implemented method of claim 3, further comprising:
extracting first time data, the first time data being a last occurring timestamp from among the first set of timestamp data; and
extracting second time data, the second time data being a first occurring timestamp from among the second set of timestamp data,
wherein the travel time data is generated based on a difference between second time data and the first time data.

6. The computer-implemented method of claim 3, further comprising:
extracting first time data corresponding to a first packet from among the first set of packets, the first packet communicated by the mobile communication device at the first location with a highest signal strength; and
extracting second time data corresponding to a second packet from among the second set of packets, the first packet communicated by the mobile communication device at the first location with a highest signal strength,
wherein the travel time data is generated based on a difference between second time data and the first time data.

7. The computer-implemented method of claim 1, further comprising:
receiving third communication data from the first wireless transceiver at a first location, the first communication data including another identification data of another mobile communication device;
receiving fourth communication data from the second wireless transceiver at the second location, the second communication data including the another identification data of the another mobile communication device;
extracting the third communication data and the fourth communication data associated with the another mobile communication device using the another identification data; and
generating another travel time data for the another mobile communication device with respect to the travel segment defined between the first location and the second location using the third communication data and the fourth communication data,
wherein the aggregated travel time data for the travel segment includes at least (i) the travel time data of the mobile communication device and (ii) the another travel time data of the another mobile communication device.

8. A system comprising:
a first wireless transceiver located at a first location, the first wireless transceiver capturing first communication data, the first communication data including identification data of a mobile communication device communicating at the first location;
a second wireless transceiver located at a second location, the second wireless transceiver capturing second communication data, the second communication data including identification data of the mobile communication device communicating at the second location; and
a computer server in data communication with the first wireless transceiver and the second wireless transceiver, the computer server being configured to perform a method that includes:
storing the first communication data from the first wireless transceiver in a database system;
storing the second communication data from the second wireless transceiver in the database system;
extracting the first communication data and the second communication data using the identification data of the mobile communication device:
generating travel time data for the mobile communication device with respect to a travel segment defined between the first location and the second location using the first communication data and the second communication data;
generating aggregated travel time data for the travel segment, the aggregated travel time data including at least the travel time data of the mobile communication device for the travel segment; and
transmitting the aggregated travel time data for visual representation in response to a request for the aggregated travel time data.

9. The system of claim 8, wherein the identification data is based on a media access control (MAC) address associated with the mobile communication device.

10. The system of claim 8, wherein:
the first communication data includes at least (a) first location data of the first location, (b) the identification data of the mobile communication device, (c) a first set of timestamp data respectively corresponding to a first set of packets the mobile communication device at the first location, and (d) a first set of received signal strength data respectively corresponding to the first set of packets; and
the second communication data includes at least (a) second location data of the second location, (b) the identification data of the mobile communication device, (c) a second set of timestamp data respectively corresponding to a second set of packets of the mobile communication device at the second location, and (d) a second set of received signal strength data respectively corresponding to the second set of packets.

11. The system of claim 10, further comprising:
computing a first median timestamp based on the first set of timestamp data corresponding to a first set of packets transmitted by the mobile communication device at the first location; and
computing a second median timestamp based on the second set of timestamp data corresponding to a second set of packets transmitted by the mobile communication device at the second location,
wherein the travel time data is generated based on a difference between the second median timestamp and the first median timestamp.

12. The system of claim 10, further comprising:
extracting first time data, the first time data being a last occurring timestamp from among the first set of timestamp data; and
extracting second time data, the second time data being a first occurring timestamp from among the second set of timestamp data,
wherein the travel time data is generated based on a difference between second time data and the first time data.

13. The system of claim 10, further comprising:
extracting first time data corresponding to a first packet from among the first set of packets, the first packet communicated by the mobile communication device at the first location with a highest signal strength; and
extracting second time data corresponding to a second packet from among the second set of packets, the first packet communicated by the mobile communication device at the first location with a highest signal strength,
wherein the travel time data is generated based on a difference between second time data and the first time data.

14. The system of claim 8, further comprising:
receiving third communication data from the first wireless transceiver at a first location, the first communication data including another identification data of another mobile communication device;
receiving fourth communication data from the second wireless transceiver at the second location, the second communication data including the another identification data of the another mobile communication device;
extracting the third communication data and the fourth communication data associated with the another mobile communication device using the another identification data; and
generating another travel time data for the another mobile communication device with respect to the travel segment defined between the first location and the second location using the third communication data and the fourth communication data,
wherein the aggregated travel time data for the travel segment includes at least (i) the travel time data of the mobile communication device and (ii) the another travel time data of the another mobile communication device.

15. A non-transitory computer readable medium having computer readable data including instructions stored thereon that when executed by a processor is configured to cause the processor to perform a method that includes:
receiving first communication data from a first wireless transceiver at a first location, the first communication data including identification data of a mobile communication device;
receiving second communication data from a second wireless transceiver at a second location, the second communication data including the identification data of the mobile communication device;
extracting the first communication data and the second communication data associated with the mobile communication device using the identification data;
generating travel time data for the mobile communication device with respect to a travel segment defined between the first location and the second location using the first communication data and the second communication data;
generating aggregated travel time data for the travel segment, the aggregated travel time data including at least the travel time data of the mobile communication device for the travel segment; and
transmitting the aggregated travel time data for visual representation on a display.

16. The non-transitory computer readable medium of claim 15, wherein the identification data is based on a media access control (MAC) address associated with the mobile communication device.

17. The non-transitory computer readable medium of claim 15, wherein:
the first communication data includes at least (a) first location data of the first location, (b) the identification data of the mobile communication device, (c) a first set of timestamp data respectively corresponding to a first set of packets the mobile communication device at the first location, and (d) a first set of received signal strength data respectively corresponding to the first set of packets; and
the second communication data includes at least (a) second location data of the second location, (b) the identification data of the mobile communication device, (c) a second set of timestamp data respectively corresponding to a second set of packets of the mobile communication device at the second location, and (d) a second set of received signal strength data respectively corresponding to the second set of packets.

18. The non-transitory computer readable medium of claim 17, further comprising:
computing a first median timestamp based on the first set of timestamp data corresponding to a first set of packets transmitted by the mobile communication device at the first location; and
computing a second median timestamp based on the second set of timestamp data corresponding to a second set of packets transmitted by the mobile communication device at the second location,
wherein the travel time data is generated based on a difference between the second median timestamp and the first median timestamp.

19. The non-transitory computer readable medium of claim 17, further comprising:
extracting first time data, the first time data being a last occurring timestamp from among the first set of timestamp data; and
extracting second time data, the second time data being a first occurring timestamp from among the second set of timestamp data,
wherein the travel time data is generated based on a difference between second time data and the first time data.

20. The non-transitory computer readable medium of claim 17, further comprising:
extracting first time data corresponding to a first packet from among the first set of packets, the first packet communicated by the mobile communication device at the first location with a highest signal strength; and
extracting second time data corresponding to a second packet from among the second set of packets, the first packet communicated by the mobile communication device at the first location with a highest signal strength,
wherein the travel time data is generated based on a difference between second time data and the first time data.
